(19) United States
(12) Patent Application Publication
(10) Pub. No.: US 2020/0166728 A1
(43) Pub. Date: May 28, 2020

(54) LENS MODULE

(71) Applicant: AAC Optics Solutions Pte. Ltd., Singapore city (SG)

(72) Inventor: Hailong Wang, Shenzhen (CN)

(21) Appl. No.: 16/695,066

(22) Filed: Nov. 25, 2019

(30) Foreign Application Priority Data
Nov. 27, 2018 (CN) 201821969336.9

(51) Int. Cl. G02B 7/02; H04N 5/225

(52) U.S. Cl. CPC G02B 7/026; G02B 7/023; H04N 5/2254

(57) ABSTRACT

The present disclosure provides a lens module, which includes a lens barrel, and a lens group accommodated in the lens barrel. The lens barrel includes a first barrel wall configured with a light through hole and a second barrel wall bending and extending from the first barrel wall. The lens group at least includes, from an object side to an image side, a first lens and a second lens matched therewith, and both the first lens and the second lens include an optical portion and a peripheral portion surrounding the optical portion. An image side surface of the peripheral portion of the first lens is provided with a first recess, and the first recess is recessed from the image side of the first lens towards the object side. An object side surface of the second lens includes a first protrusion fixed in the first recess.

### TECHNICAL FIELD

The present disclosure relates to the field of pick-up lens, and more particularly, to a lens module.

### BACKGROUND

With the continuous development of science and technology, electronic devices are continuously developing towards intelligence, and portable electronic devices such as tablet computers, cell phones and the like are also equipped with lens modules, except for digital cameras. In order to meet the needs of people, higher requirements for image quality of an object photographed by lens modules are also put forward.

In current lens structure, a circle bumpy ridge joining is adopted between lenses, but due to poor roundness of the bumpy ridge joining of the lenses, it is easy to be improperly assembled during assembly, thus affecting the performances of the lenses. In addition, a light shielding plate is generally matched with the lens at an outer circle, but due to the extremely poor roundness of the outer diameter of the light shielding plate, it is easy to be misaligned or not properly assembled during assembly, thus affecting the performances of the lens. The matching method between the components of the current lens still has much room for improvement. In order to achieve more stable matching between the components and improve the overall performances of the lens, it is necessary to provide a novel lens module.

### BRIEF DESCRIPTION OF THE DRAWINGS

FIG. 1 is a structural sectional view of a lens module of the present disclosure;

FIG. 2 is a structural sectional view of the lens module of the present disclosure from another angle;

FIG. 3 is a structural sectional view of a lens barrel of the present disclosure;

FIG. 4 is a stereostructure view of a first lens of the present disclosure;

FIG. 5 is a plan view of a second lens of the present disclosure;

FIG. 6 is a partial sectional view of a third lens matched with a light shielding plate of the present disclosure;

FIG. 7 is a partial sectional view of the third lens matched with the light shielding plate of the present disclosure from another angle; and

FIG. 8 is a stereostructure view of a shielding plate of the present disclosure.

### DETAILED DESCRIPTION

In order to better understand the solutions of the present disclosure and advantages thereof in various aspects, the present disclosure will be described in further detail below with reference to the drawings through specific embodiments. In the following embodiments, a left-right direction in a principal plane is taken as a horizontal direction, and a direction in the principal plane perpendicular to the horizontal direction, i.e., an up-down direction in the principal plane is taken as a vertical direction. In the present disclosure, a direction of a central axis is parallel to the vertical direction.

### Embodiment 1

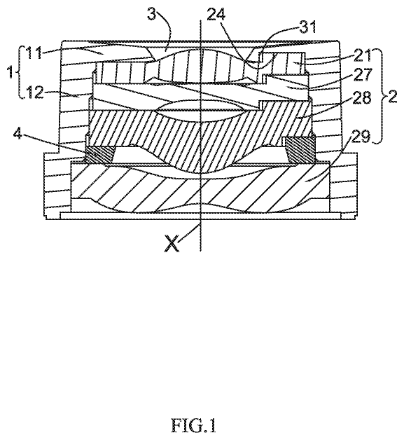

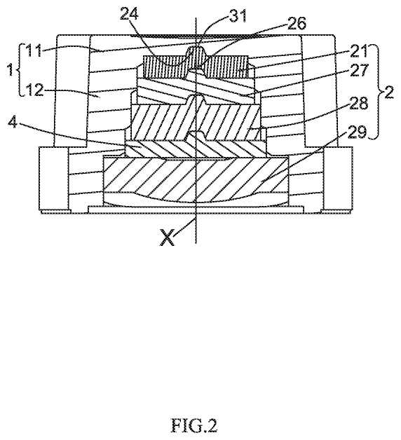

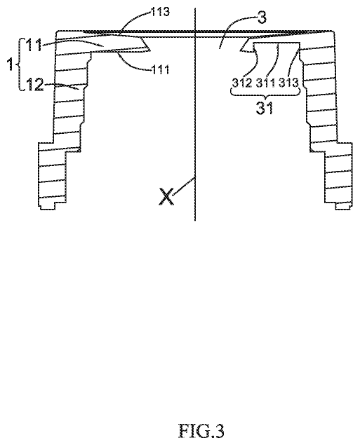

Referring to FIG. 1, FIG. 2 and FIG. 3, the present disclosure provides a novel lens module, including a lens barrel 1 and a lens group 2 accommodated in the lens barrel 1, wherein the lens group 2 at least includes, from an object side towards an image side, a first lens 21 and a second lens 27 mutually matched with each other.

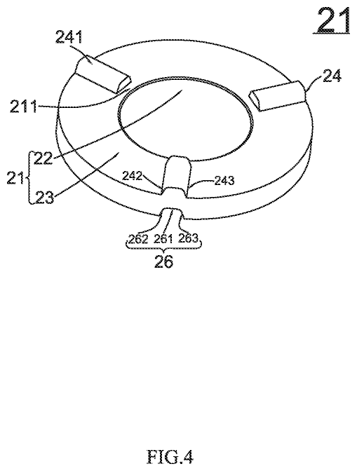

In the embodiment, as shown in FIG. 2, FIG. 3 and FIG. 4, the lens barrel 1 includes a first barrel wall 11 configured with a light through hole 3 and extending along a horizontal direction, a second barrel wall 12 bending and extending from the first barrel wall 11, and an accommodating space defined by the first barrel wall 11 and the second barrel wall 12, wherein the first barrel wall 11 includes a first surface 111 located at an image side and a second surface 113 located at an object side. The lens barrel 1 may either be of an integral structure or a split structure.

In order to improve a matching precision between the lenses and a yield rate of assembly, a structure of the first lens 21 and a structure of the second lens 27 are improved, and the detail solution is as follows.

As shown in FIG. 2 and FIG. 3, an upper surface of the first lens 21 is an object side surface, and a lower surface of the first lens 21 is an image side surface. The first lens 21 includes an optical portion 22 and a peripheral portion 23 surrounding the optical portion 22.

As shown in FIG. 4, an image side surface of the peripheral portion 23 of the first lens 21 is provided with a first recess 26, and the first recess 26 is spaced apart from the optical portion 22. The first recess 26 includes a first bottom surface 261, a first side wall 262 and a second side wall 263 both connected with the first bottom surface 261 and obliquely extending from the first bottom surface 261 towards the second lens 27. A width of the first recess 26 gradually decreases from the image side to the object side. In the embodiment, three first recesses 26 are provided, and the three first recesses 26 are evenly arranged along the image side surface of the peripheral portion of the first lens 21.

Further, the object side surface of the peripheral portion 23 of the first lens 21 includes three second protrusions 24 evenly distributed along a circumference of the first lens 21, and the three second protrusions 24 are preferably arranged at equal intervals, but can also be arranged at unequal intervals. The second protrusion 24 protrudes from the first lens 21 towards the first surface 111 of the first barrel wall 11, and an end surface of an outer edge of the second protrusion 24 is attached to an inner wall surface of the second barrel wall 12. An upper surface of the second protrusion 24, i.e., an object side surface thereof is attached to the first surface 111 of the first barrel wall 11. The object side surface of the peripheral portion 23 of the first lens 21 further includes a first plane 211 connected with the second protrusion 24 and horizontally extending towards an optical axis X, and the first plane 211 is partially attached to the first surface 111 of the first barrel wall 11.

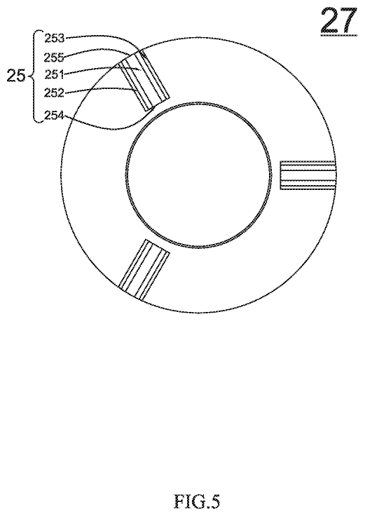

As shown in FIG. 5, an object side surface of the peripheral portion of the second lens 27 includes a first protrusion 25 fixed in the first recess 26, and the first protrusion 25 protrudes from the object side surface of the second lens 27 towards the first lens 21 (i.e., from the image side to the object side). A number of the first protrusion 25 is equal to a number of the first recess 26, and the positions of the first protrusion 25 and the first recess 26 are corresponding. The first protrusion 25 includes a first side surface 251 adjacent to the object side, a second side surface 252 and a third side surface 253 both connected with the first side surface 251. The first side surface 251 is spaced apart from the first bottom surface 261, the second side surface 252 is attached to the first side wall 262, and the third side surface 253 is attached to the second side wall 263. The first protrusion 25 further includes a first end surface 254 adjacent to the optical axis X and a second end surface 255 adjacent to the second barrel wall 12. The first end surface 254 is spaced apart from a corresponding surface of the first lens 21.

In the embodiment, a structure of the second protrusion 24 is the same as that of the first protrusion 25, and a number of the second protrusion 24 and a number of the first protrusion 25 are both three, but not limited to three. Specifically, the second protrusion 24 includes an upper surface 241 adjacent to the object side, an inner end surface connected with the upper surface 241 and adjacent to the optical axis X, and an outer end surface close to the second barrel wall 12.

Further, the first surface 111 of the first barrel wall 11 includes a third recess 31 matched with a shape of the second protrusion 24. The third recess 31 has the same structure as that of the first recess 26. As can be seen from FIG. 3, the third recess 31 includes a third bottom surface 311, a fifth side wall 312 and a sixth side wall 313 connected with the bottom surface 251 and extending vertically from the bottom surface 251 towards the first lens 21. The fifth side wall 312 is closer to the optical axis X than the sixth side wall 313. The third bottom surface 311 is spaced apart from the upper surface 241 of the second protrusion 24. The inner end surface of the second protrusion 24 is spaced apart from the fifth side wall 312, and the outer end surface of the second protrusion 24 is attached to the inner wall surface of the second barrel wall 12. A width of the third recess 31 gradually decreases from the image side to the object side.

Moreover, an image side surface of the peripheral portion of the second lens 27 includes a fourth recess as same as the first recess 26. A structure of a peripheral portion of a third lens 28 is the same as or different from a structure of the peripheral portion of the second lens 27. In addition, the lens group further includes a fourth lens 29 located at an image side of the third lens 28, and is not limited thereto. The example above is only used for illustration.

### Embodiment 2

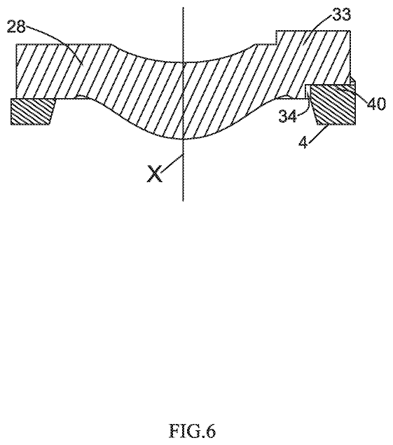

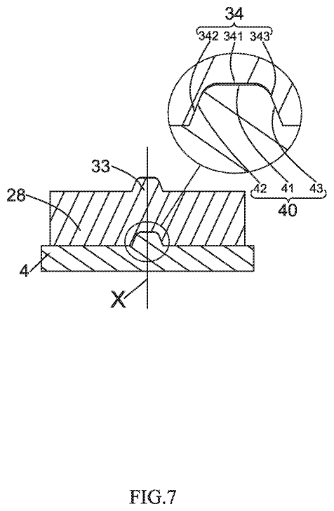

The present disclosure further provides a lens module, what is different from Embodiment 1 is that, a lens group 2 at least includes a lens matched with a shielding plate 4, and the lens is located at an object side of the shielding plate 4. In the embodiment, as shown in FIG. 1, FIG. 6 and FIG. 7, the lens is the third lens 28, and an object side surface of the peripheral portion of the third lens 28 includes a third protrusion 33 as same as the first protrusion 25. Three third protrusions 33 are provided and the three third protrusions 33 are arranged at equal intervals along a circumference of the third lens 28. An image side surface of the peripheral portion of the third lens 28 includes at least two second recesses 34 equally distributed along the circumference of the third lens 28. Preferably, the plurality of second recesses 34 are arranged at equal intervals, and the second recess 34 is the same as the first recess 26. Specifically, the second recess 34 includes a second bottom surface, a third side wall and a fourth side wall connected with the second bottom surface and obliquely extending from the second bottom surface towards the shielding plate. A width of the second recess 34 gradually decreases from the image side to the object side.

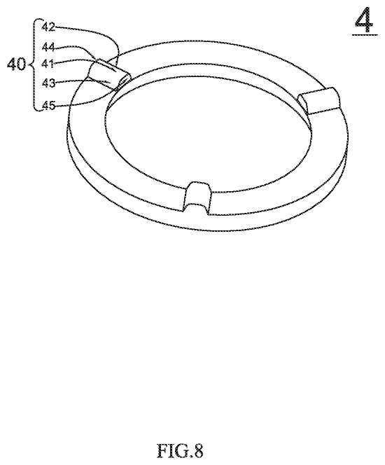

As shown in FIG. 8, the shielding plate 4 is an annular member. The shielding plate 4 includes a fourth protrusion 40 accommodated and fixed in the second recess 34. The fourth protrusion 40 protrudes from an object side surface of the shielding plate 4 towards the third lens 28 (the first barrel wall 11). The fourth protrusion 40 is accommodated and fixed in the second recess 34. A number of the fourth protrusion 40 is equal to a number of the second recess 34.

In the embodiment, the second recess 34 includes a second bottom surface 341, a third side wall 342 and a fourth side wall 343 both connected with the second bottom surface 341 and obliquely extending from the second bottom surface 341 towards the shielding plate 4. A width of the second recess 34 gradually decreases from the image side to the object side.

In the embodiment, three fourth protrusions 40 are provided, and a number of the fourth protrusion 40 is equal to a number of the second recess 34. The three fourth protrusions 40 are arranged at equal intervals along a circumference 4 the shielding plate. The third protrusion 33 and the fourth protrusion 40 have the same structure; therefore, the illustration on the third protrusion 33 is omitted.

Further, the fourth protrusion 40 includes a fourth side surface 41 adjacent to the object side, a fifth side surface 42 and a sixth side surface 43 located at two sides of the fourth side surface 41, the fourth side surface 41 is spaced apart from the second bottom surface 341, the fifth side surface 42 is attached to the third side wall 342, and the sixth side surface 43 is attached to the fourth side wall 343. The fourth protrusion 34 further includes a third end surface adjacent to the optical axis X and a fourth end surface adjacent to the second barrel wall 12. The third end surface is spaced apart from a corresponding side surface of the second recess 34. The fourth end surface is attached to the inner wall surface of the second barrel wall 12.

In the structure above, the three first protrusions 25 evenly divide the second lens 27 into three portions, and match with the first recess 26 of the first lens 21, so that bearing between the first lens 21 and the second lens 27 is smoother, thus not only ensuring an outer diameter precision of the lens, but also ensuring a matching precision of the lenses, and improving the stability of the lens. Similarly, the three fourth protrusions 40 evenly divide the shielding plate 4 into three portions, and matched with the second recess 34 of the third lens 28, so that bearing between the third lens 28 and the shielding plate 4 is smoother, thus not only ensuring an outer diameter precision of the lens, but also ensuring a matching precision of the lens and the shielding plate, and improving the stability of the lens.

Moreover, the lens group 2 further includes a fourth lens 29 located at an image side of the third lens 28, and a number of the lens is not limited thereto. In addition, a shielding member can be arranged among the lenses, and the shielding member can also be omitted.

Compared with the prior art, the lens module of the present disclosure can ensure outer diameter precision of each component, and the mutual matching between the lens and the lens barrel, the lens and the lens, and the lens and the shielding plate is more accurate, thus improving the stability of the lens; and has a high matching precision, is more stable to match with the lens barrel, thus improving an overall performance of the lens.

The description above is merely the embodiments of the present disclosure, and it should be pointed out that those of ordinary skills in the art may make improvements without departing from the concept of the present disclosure, and all these improvements shall belong to the scope of protection of the present disclosure.

What is claimed is:

1. A lens module, comprising a lens barrel, and a lens group accommodated in the lens barrel, wherein the lens barrel comprises a first barrel wall configured with a light through hole and a second barrel wall bending and extending from the first barrel wall; and the lens group at least comprises, from an object side to an image side, a first lens and a second lens matched with the first lens, and both the first lens and the second lens comprise an optical portion and a peripheral portion surrounding the optical portion; wherein, an image side surface of the peripheral portion of the first lens is provided with a first recess, and the first recess is recessed from the image side of the first lens towards the object side; and an object side surface of the second lens comprises a first protrusion fixed in the first recess.

2. The lens module according to claim 1, wherein the first recess comprises a first bottom surface, a first side wall and a second side wall both connected with the first bottom surface and obliquely extending from the first bottom surface towards the second lens; and a width of the first recess gradually decreases from the image side to the object side.

3. The lens module according to claim 2, wherein the first protrusion is spaced apart from the optical portion of the second lens, and the first protrusion extends from an outer edge of the peripheral portion of the second lens towards an optical axis without reaching the optical portion.

4. The lens module according to claim 3, wherein a number of the first protrusions is designated as three, and the three first protrusions are arranged at equal intervals along a circumference of the second lens; and a number of the first recess is equal to the number of the first protrusion.

5. The lens module according to claim 4, wherein the first protrusion comprises a first side surface adjacent to the object side, a second side surface and a third side surface located at two sides of the first side surface, the first side surface is spaced apart from the first bottom surface, the second side surface is attached to the first side wall, and the third side surface is attached to the second side wall.

6. A lens module, comprising a lens barrel, a lens group and a shielding plate accommodated in the lens barrel, wherein the lens barrel comprises a first barrel wall configured with a light through hole and a second barrel wall bending and extending from the first barrel wall; and the lens group at least comprises a lens matched with the shielding plate and located at an object side of the shielding plate, and the lens comprises an optical portion and a peripheral portion surrounding the optical portion; wherein, an image side surface of the peripheral portion of the lens comprises a second recess, and the second recess is recessed from an image side towards the object side; and the shielding plate comprises a fourth protrusion fixed in the second recess.

7. The lens module according to claim 6, wherein the second recess comprises a second bottom surface, a third side wall and a fourth side wall both connected with the second bottom surface and obliquely extending from the second bottom surface towards the shielding plate; and a width of the second recess decreases from the image side to the object side.

8. The lens module according to claim 7, wherein the shielding plate is an annular member; and the fourth protrusion protrudes from an object side surface of the shielding plate adjacent to the object side towards the first barrel wall.

9. The lens module according to claim 8, wherein a number of the fourth protrusions is designated as three, and the three fourth protrusions are arranged at equal intervals along a circumference of the shielding plate; and a number of the second recess is equal to the number of the fourth protrusion.

10. The lens module according to claim 9, wherein the fourth protrusion comprises a fourth side surface adjacent to the object side, a fifth side surface and a sixth side surface located at two sides of the fourth side surface, the fourth side surface is spaced apart from the second bottom surface, the fifth side surface is attached to the third side wall, and the sixth side surface is attached to the fourth side wall.
